(19) United States
(12) Patent Application Publication
(10) Pub. No.: US 2015/0058153 A1
(43) Pub. Date: Feb. 26, 2015

(54) SYSTEM AND METHODS FOR AN ELECTRONIC COMPUTER-IMPLEMENTED PORTAL FOR OBTAINING AND OFFER SERVICES

(71) Applicant: Vahe TAZIAN, Beverly Hills, MI (US)

(72) Inventor: Vahe TAZIAN, Beverly Hills, MI (US)

(73) Assignee: Two Shouts, LLC, Beverly Hills, MI (US)

(21) Appl. No.: 13/971,389

(22) Filed: Aug. 20, 2013

(51) Int. Cl. G06Q 30/06

(52) U.S. Cl. CPC G06Q 30/0613; G06Q 30/0611
USPC 705/26.4

(57) ABSTRACT

The present invention provides an electronic, computer implemented portal among service providers and service seekers. The system and methods allow the service seeker to post an electronic submission for services or the service provider to post an electronic submission for services to be provided. The system provides a non-negotiable functionality, which allows parties to instantly contract. In one variation, the service seeker may create a sufficiently detailed submission which can be answered by a service provider. In a second variation, the service provider may create a sufficiently detailed submission to perform services, which can be answered with a non-negotiable, binding legal acceptance from a service seeker. The system also provides a negotiable functionality, in which parties can negotiate aspects of the offer.

### FIELD OF THE INVENTION

The invention relates to a system and method for providing an electronic, computer implemented portal to facilitate communication and exchanges for the contracting for services between service providers and service seekers.

### BACKGROUND OF THE INVENTION

In the conventional marketplace for services, there are two parties made up of individuals or groups, such as business entities: service seekers and service providers. This marketplace allows for two general paradigms: 1) the service seeker seeks a service to be performed and/or delivered by a commissioned service provider who must generate and render the service at the distinct request of the service seeker; and 2) a service provider announces his/her availability or desire to provide a defined set of services to a service seeker

With respect to the first paradigm, a service seeker usually places an advertisement, solicitation, request or post, in print or electronic classifieds bulletin boards or ecommerce sites (e.g., a newspaper or Craigslist® (San Francisco, Calif.)), or via a real or virtual (electronic) social network (e.g., a civic association, Facebook® (Palo Alto, Calif.); Twitter® (San Francisco, Calif.)), describing the desired services. Such an action by the service seeker is typically treated as an invitation to treat (e.g., a non-binding request for proposals or inquiries by interested parties) in legal terms, in which the service seeker does not intend to be bound to those responding to the service seeker's advertisement, solicitation, request or post. Such advertisements, solicitations, requests or posts referred to above are collectively referred to herein as a “non-binding solicitation.”

Any service provider in receipt of the non-binding solicitation can respond, perhaps to express an interest, seek additional information, or display qualifications, without accepting the solicitation or terms thereof. In other words, no definitive or binding obligations to perform the services are associated with such a response. Thus, such response is considered non-binding against the service provider. As a result, the initial advertisement must lead to or involve subsequent steps, or additional interaction between the service provider and service seeker in order to effectuate or consummate a conventional business contract or to meet the elements of a binding agreement. Typically, in such situations, the service seeker and the interested service provider would engage in dialogue, often in the form of negotiations of terms, before a final agreement is reached between the parties and any services are rendered by the service provider on behalf of the service seeker.

With respect to the second paradigm, a service provider interested in providing or making available his/her services would engage in a similar exchange as in the first paradigm. Conventionally, the service provider would place a non-binding solicitation on the electronic or print classifieds or bulletin board. Typically, such a non-binding solicitation announces a service that the service provider can provide or deliver to interested service seekers. Such non-binding solicitations typically provide generalities regarding the types of the services offered and perhaps additional information such as starting price and contact information, which are not necessarily specific to any particular engagement. As in the first paradigm, a service seeker may then reply in a non-binding response without commitment to a formal business relationship. This may then lead to further dialogue and negotiations before a definitive deal is reached between the parties.

Both paradigms, however, are inherently inefficient. Cycles of negotiation and back-and-forth exchanges between the service provider and the service seeker are unnecessary byproducts of the conventional marketplace. The time and resources required to reach a mutually agreeable agreement between the parties when starting from non-binding solicitation (e.g., an advertisement) inevitably delay delivery and/or performance services, and in turn, completion of the services transaction. In some circumstances the administrative burden associated with time-consuming negotiations may outweigh or otherwise diminish the net benefit of receiving the desired services. A common sentiment felt by service seekers is that negotiation for services may take more time than performing the services themselves. This inefficiency is particularly glaring where the services to be rendered: 1) are relatively inexpensive in cost and/or short in duration; 2) are to be performed for a fixed or pre-determined price (e.g., manicure for $10; shuttle service for $25, etc.); 3) have well-defined parameters and scope (e.g., paint 2 coats of eggshell paint on the walls of a 10 foot by 10 foot room; remove garbage from the identified premises, etc.) and/or 4) are common, frequently performed, or well-understood services (e.g., livery service from the airport to a residential destination within a certain geographical radius; install a ceiling fan, walk a dog 20 minutes twice a week, etc.).

There is no conventional medium, electronic or otherwise, in which a service seeker or service provider can efficiently solicit a plurality of the other and create a substantially immediate binding agreement for the performance of services. First, there is a need in the art to provide a system and method to streamline the marketplace to acquire and/or provide services by removing the negotiation component, which sites like Craigslist.org® (Craigslist, San Francisco, Calif.) inherently involve. If such a need is met, the system and method would enhance the relationship between service seekers and service providers by facilitating a faster, more convenient and definitive manner of acquiring and delivering services. Second, there is a need in the art to provide an electronic portal among service seekers and service providers to allow a free exchange between these parties without a middleman, administrator or the like intervening or prescreening service providers or steering users towards a pool of preselected service providers, such as in some conventional marketplaces (e.g., TaskRabbit® (San Francisco, Calif.)). Specifically, there is an unmet need in the art to provide an electronic classified portal among service seekers and service providers to request or obtain services, whereby a service provider can transform elements of an advertisement into an offer and a service seeker can transform a traditional response to the advertisement into an acceptance of the underlying offer.

### SUMMARY OF THE INVENTION

The present invention meets the unmet needs in the art by providing a computer-implemented system and method for enabling a service seeker and a service provider to facilitate acquisition of services by a service seeker and performance of services by a service provider, at defined prices, times and locations. Accordingly, users of the system and method herein are made up of two groups: a group comprised of one or more service seekers and a group comprised of one or more service providers. Aspects of the present invention include hosting a computer-implemented, electronic portal, preferably over the internet through internet-enabled mobile and desktop devices, for the users to search, communicate, engage, and transact. A communication may be initiated by a member of a first group, either the service seeker or the service provider, and includes at least a description of a service (service being requested or service being offered), and a value associated with the service, and the location and a date (e.g., the time period in which the offer remains valid or the tune period in which when the services can/must be rendered).

The portal (alternatively referred to herein as the “market,” “marketplace,” “exchange,” or “system”) electronically processes the communication and electronically displays and/or makes accessible such communication to other users, including preferably one or more members of a second group (i.e., the service provider if the service seeker initiated the communication or the service seeker if the service provider initiated the communication). Users can respond to the communication. For example, the system allows one or more members of the second group to reply electronically to the communication, where the system processes such response communication and makes such response communication electronically available to the member of the first group initiating the communication.

In certain embodiments, the system associates fees or monetary values with user actions made through the system. For example, the system may assess fees for the member of the first group, the member(s) of the second group (preferably members responding to the communication, and more preferably members selected in the second group), or both members of the first and second group. The fees may be transactional and/or subscription-based, in nature.

In preferred embodiments, the communication initiated by the member of the first group is deemed, or is treated as, a binding, preferably firm, non-negotiable, offer, under the law or by other convention. In such embodiments, the binding offer may be revoked as permitted by applicable law. For example, the system may be configured to allow the party initiating the binding offer to revoke the offer prior to acceptance. Similarly, the response communication by the member of the second group is deemed, or is treated as, a binding acceptance, by law or other convention. Such offer and acceptance creates a binding contract, under law and/or the terms of the system. The system may be configured to comply or follow applicable laws to formalize and/or enforce such contract. In more preferred embodiments, when multiple replies are received by the system, the system selects the response communication(s) based on a predetermined condition. The system electronically transmits or displays the selected response communication(s) to the member of the first group initiating the communication. Parties are linked and a contract is formed between the member of the first group and such selected member(s) of the second group. In the most preferred embodiments, the offer, acceptance, and corresponding contract are legally binding and/or enforceable.

In other preferred embodiments, the communication from the member of the first party includes predetermined criteria, such as a minimum acceptable value or counter-offer amount the “floor”). The system identifies, evaluates, and/or classifies aspects of, or elements of, the response communications related to the predetermined criteria and processes the response communications with respect to such elements. The system transmits or displays to the member of the first party response communications meeting the predetermined criteria. Preferably then, response communications failing to meet or exceed the floor are rejected (i.e., not communicated to first party), may be communicated to the first party with some delay (e.g., may be communicated after a predetermined amount of time if the first party does not receive any other offers meeting or exceeding the floor within another predetermined amount of time) or may communicated to the first party only if further requested by the first party. In more preferred embodiments, the system displays or transmits to the member of the first party the response communications that meet or exceed the floor. In some embodiments, the response communications are ordered by the predetermined value, such as the value, and the response communications are transmitted or displayed in such order (i.e., highest value to lowest value). Certain preferred variations of these embodiments may permit negotiable solicitations and communications, rather than binding offers.

Another aspect of the present invention is a processor-readable medium storing code representing instructions to cause a processor to perform a process to engage in a transaction using virtual funds, said code comprising code to host a computer-implemented electronic portal to facilitate an electronic communication between a plurality of users communicably linked through a network, wherein (1) the plurality of users consists of a group comprised of one or more service seekers and a group comprised of one or more service providers; (2) the communication is between the group of one or more service seekers and the group of one or more service providers; (3) the communication is initiated by a member of a first group; and (4) the communication is comprised of a description of a service and value of the service. Additionally, such code comprises code to provide a graphical user interface to record the communication initiated by a member of the first group, receive the communication initiated by the member of the first group, treat the communication initiated by the member of the first group as a binding offer, process the binding offer to be electronically accessible to one or more members of a second group, receive one or more response communications corresponding to the one or more members of the second group, process the response communications; select the response communication of a selected member of the second group; transmit the selected response communication to the member of the first group initiating the communication; treat the selected response communication as a binding acceptance; record the offer from the member of the first group initiating the communication and the acceptance from the selected member of the second group as a contract; and notify the member of the member of the first group initiating the communication and the selected member of the second group of the contract.

An additional aspect of the present invention is a computer-implemented, electronic system, which comprises: an electronic processor; a data bus coupled to said processor; and a computer-usable medium embodying computer code, said computer-usable medium being coupled to said data bus. Such computer program code comprises instructions executable by said processor and is configured for: hosting a computer-implemented electronic portal to facilitate an electronic communication between a plurality of users communicably linked through a network, wherein the plurality of users consists of a group comprised of one or more service seekers and a group comprised of one or more service providers; wherein the communication is between the group of one or more service seekers and the group of one or more service providers; wherein the communication is initiated by a member of a first group; and wherein the communication is comprised of a description of a service and value of the service. Such computer program code is also configured for providing a graphical user interface to record the communication initiated by a member of the first group; receiving the communication initiated by the member of the first group; treating the communication initiated by the member of the first group as a binding offer; processing the binding offer to be electronically accessible to one or more members of a second group; electronically receiving one or more response communications corresponding to the one or more members of the second group; processing the response communications; selecting the response communication of a selected member of the second group; electronically transmitting the selected response communication to the member of the first group initiating the communication; treating the selected response communication as a binding acceptance.

Any of the embodiments illustrated above and below stand independently or features may be combined to achieve preferred embodiments. Additional advantages and embodiments of the invention will also become more apparent to those of ordinary skill in the art upon review of the teachings of the present application.

### BRIEF DESCRIPTION OF DRAWINGS

Further advantageous features of the present invention will become more apparent with the following detailed description when taken with reference to the accompanying drawings in which:

FIG. 1 illustrates exemplary system, wherein end user devices and the system are functionally interconnected through an electronic network, in accordance with one or more embodiments of the present invention;

FIG. 2 illustrates exemplary system architecture, in accordance with one or more embodiments of the present invention;

FIG. 3 illustrates an exemplary flow diagram of a method to exchange services between a service provider and a service seeker, wherein the service seeker posts a communication to an electronic exchange/portal, in accordance with one or more embodiments of the present invention;

FIG. 4 illustrates an exemplary flow diagram of a method to exchange services between a service provider and a service seeker, wherein the service provider posts a communication to an electronic exchange/portal, in accordance with one or more embodiments of the present invention;

FIG. 5 illustrates an exemplary flow diagram of a method to exchange services between a service provider and a service seeker, wherein the service seeker posts a communication to an electronic exchange, wherein the communication includes certain parameters of the service being sought, in accordance with one or more embodiments of the present invention;

FIG. 6 illustrates an exemplary flow diagram of a method to exchange services between a service provider and a service seeker, wherein the service provider posts a communication to an electronic exchange, wherein the communication includes certain parameters of the service being provided, in accordance with one or more embodiments of the present invention;

FIG. 7 illustrates an exemplary flow diagram of a method to invoice or exchange payment for services between a service provider and a service seeker, in accordance with one or more embodiments of the present invention;

FIG. 8 illustrates an exemplary flow diagram of a method to exchange services between a service provider and a service seeker which illustrates the business relationship between the parties, in accordance with one or more embodiments of the present invention;

FIG. 9 illustrates an exemplary flow diagram of a method to exchange services between a service provider and a service seeker which further illustrates the establishment of the business relationship between the parties, in accordance with one or more embodiments of the present invention;

FIGS. 10A-D illustrate a schematic diagram of the parties and the methods involved in exchanging services between such parties, in accordance with one or more embodiments of the present invention;

FIG. 11 illustrates the formation of a legal business relationship between the parties, in accordance with one or more embodiments of the present invention;

FIG. 12 illustrates an exemplary flow diagram of the registration module, in accordance with one or more embodiment, in accordance with one or more embodiments of the present invention;

FIG. 13 illustrates an exemplary flow diagram of the ratings module, in accordance with one or more embodiments of the present invention; and

FIG. 14 illustrates a second exemplary flow diagram of the ratings module, in accordance with one or more embodiments of the present invention.

The flowchart and block diagrams, as well as the graphical user interface images, in the Figures illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). The flow diagrams depicted herein are just a few examples. There may be many variations to this diagram or the steps (or operations) described therein without departing from the spirit of the disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### DETAILED DESCRIPTION OF THE PREFERRED EMBODIMENTS

The present invention provides systems and methods to an electronic, computer implemented portal to facilitate communication and contracting for services among service providers and service seekers. The basic goal of the system and methods described and disclosed herein is to connect service providers to service seekers (and service seekers to service providers) to facilitate acquisition or commission of services by a service seeker from a service provider performing the services. Either the service provider or the service seeker may initiate the connection.

The detailed description presents various embodiments of computer-implemented method and system for enabling users to engage to facilitate a service seeker obtaining services from a service provider providing, or willing to provide, services. In particular, the use of the various embodiments with various types and formats of user interface presentations will be described. It will be apparent to those of ordinary skill in the art that alternative embodiments of the implementations described herein can be employed and still fall within the scope of the claimed invention. It will be understood that the invention is not limited to the specific embodiments disclosed herein but is capable of numerous modifications by one of ordinary skill in the art. It will be further understood that the materials used and technological details may be slightly different or modified from the descriptions herein without departing from the methods and compositions disclosed and taught by the present invention. Many variations and modifications will be apparent to those of ordinary skill in the art.

As noted above, service seekers desire to find or obtain services or the performance of services from another party for legal consideration (e.g., money or something of value). Service providers desire to provide a service or perform a service for and/or on the behalf of the other party. As used herein, the term “user(s)” broadly encompasses any party having access to, and preferably having credentials, e.g., log in and password, to the site. This may include members, individuals, groups, partnerships, corporations, organizations, or other entities. Users may be classified as consumers (e.g., a customer) and/or businesses (e.g., a vendor, supplier). In preferred embodiments, users are classified as service providers and/or service seekers. In preferred embodiments, a singular user may be both a service provider and a service seeker, depending on the circumstances, including the service being sought or performed. In other words, any particular user may have multiple roles which can change on occasion (e.g., depending on the service). A user can be a service provider, a service seeker, or both. System administrators may be deemed users. System administrators preferably have access to data and information necessary to allow the system to run smoothly. System administrators may be granted varying degrees of privileges to such data and information, as would be understood in the information technology art.

Users access the exchange through an electronic, computer-implemented interface (e.g., a web-interface). The interface may comprised of a series of lists, forms, text fields, and other display techniques that implement several classes that consist of data elements and methods. The data elements and methods are abstracted to a level that can be applied to all object oriented programming languages. The interface is generally referred to a graphically user interface (GUI). Generally, the GUI is accessible using input devices (e.g., a keyboard and mouse), as further described below, or by touch (e.g., a capacitive touch screen).

As used herein, the term “portal” or “exchange,” as used interchangeably herein, refers to an electronic “environment,” “computer-implemented network,” or “network” that encompasses a virtual, computer-implemented, network-based platform accessible to at least two users, and preferably a plurality of users. The portal may be, or includes aspects of, a conventional, virtual or online social-network, bulletin board, or marketplace. As further noted in latter parts of this description, to access the portal, users control computer-implemented devices (including computers, mobile devices, clients and servers) which are communicably linked via a network, such as preferably the Internet. The internet networked is commonly referred to as “online” and/or the “Web” and devices thereon are deemed to be “online” and/or “web-enabled,” “Computer-implemented” is functionally equivalent, and generally includes, the concepts of processor-based, electronic or computerized. The portal may appear to be, or actually be, a website, program, or application (also commonly referred to as “app”). The exchange, which receives data and information electronically, may include a system of computers, processors or electronic components as well as one or more system administrators and/or personnel manually inputting, manipulating or otherwise handling such data and information on the system. In preferred embodiments, the portal is presented in the form of a website or “site”.

In a preferred configuration of the invention, a user of the site registers with the site, as is understood in the art. The system may provide a proprietary system, or use a third-party system. For example, companies such as Facebook (Palo Alto, Calif.), Twitter (San Francisco, Calif.), Google (Mountain View, Calif.), or Amazon (Seattle, Wash.) provide commercially available application programming interfaces (APIs) for such a purpose. For example, Facebook Connect® (Facebook, Palo Alto, Calif.) allows users to log on to a system (e.g., an app or a website) by accessing and/or inputting credentials from the users Facebook® social network account. Generally, the system provides, confirms, or verifies user credentials, which may include an identifier, such as a log in or username, and a password or electronic key. The system may allow non-registered users to access the system (e.g., the website). Preferably, non-registered users have view-only access, meaning only registered users can input, post, submit information on the system.

User registration is generally understood in the art, particularly with respect to ecommerce and social media, to include user-specific information, including for example, the user's personal information (e.g., name, address, email address, phone numbers, age), payment information (e.g., credit card and/or bank information), and demographic information (e.g., gender, income level, etc.). The specific composition of the information collected and required may be determined and customized by the system. In preferred embodiments, it is contemplated that any information collected, stored, distributed, shared, and displayed would be in compliance with any applicable laws. Additionally, user registration may include user preferences, such as preferences related to privacy and sharing, notifications, and system-specific rules and actions, many of which are common on social networking and/or membership sites. Information required by the site may be configured according to preferences and needs. For example, financial information, such as credit card information may only be required if such information is needed (e.g., the site charges user fees for services).

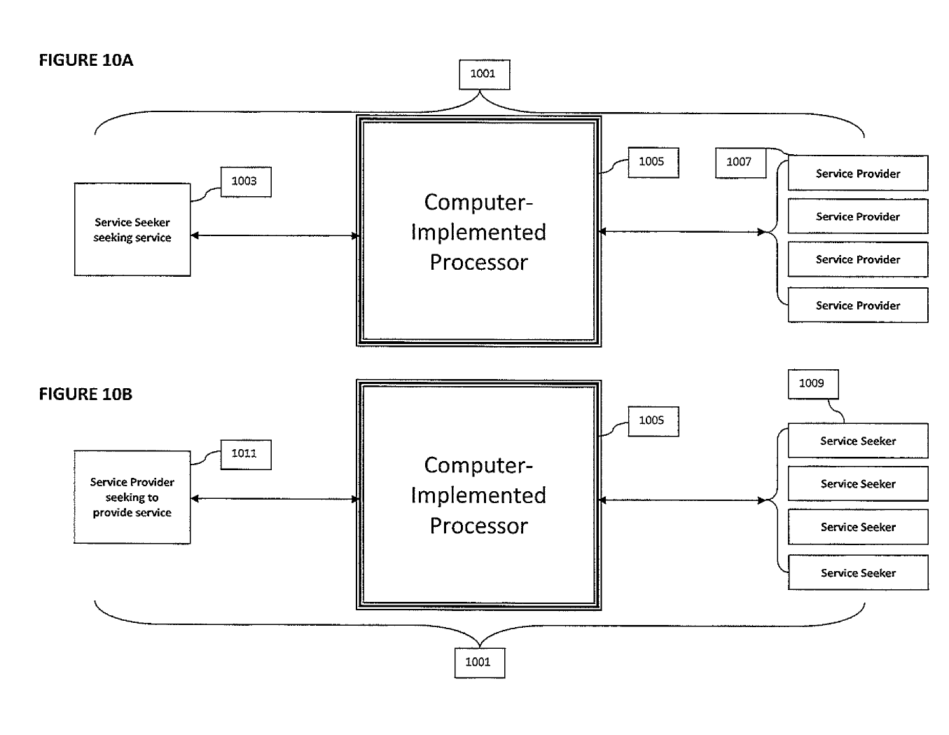

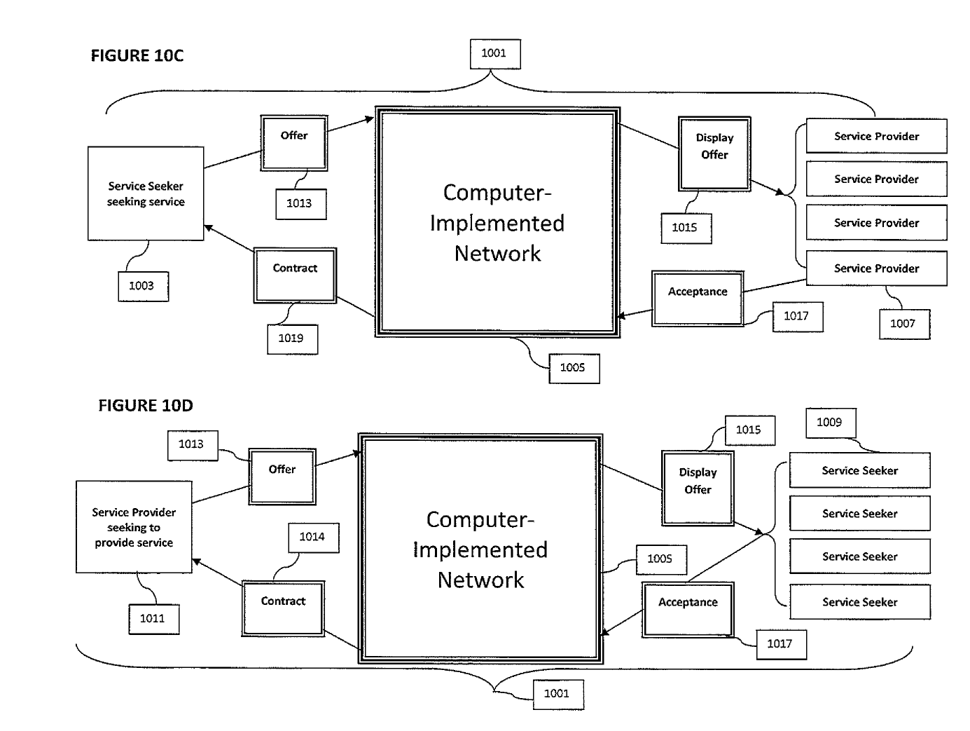

In embodiments of the present invention, as shown in FIGS. 10A and 10B, either a service seeker 1003 or a service provider 1011 may submit a post on or through the portal/exchange 1001 to one or more recipients, who may be generally referred to as the “audience,” “community,” “users,” or “registered users.” When a service seeker 1003 submits a communication (interchangeably referred to herein as a “submission” or “post”) through the system 1005, the intended audience is comprised of one or more “service providers” 1007. The system (e.g., via user selected preferences or system-based rules) may optionally expand the audience to include “service seekers” or other users, including system administrators. When a service provider 1011 submits a communication, the intended audience is comprised of “service seekers” 1009. The system (e.g., via user selected preferences or system-based rules) may optionally expand the audience to include “service providers” or other users, including system administrators.

In certain embodiments, the system provides a method for replying to the submission, in which the service seeker's submission constitutes, or is deemed to be, a legal, non-negotiable (fixed), binding offer and the reply by the service provider constitutes, or is deemed to be, a legal, binding acceptance. FIGS. 10C and 10D illustrate the general principles of contract formation in the exchange 1001. In FIG. 10C, the service seeker 1003 creates a submission. In accordance with system rules, and preferably under applicable law, the submission is deemed a legally binding offer 1013. The system transmits and/or displays 1015 the offer over a network 1005 composed of one or more service providers 1007. A response communication interchangeably referred to herein as a “reply” or “response”) by the service provider(s) would constitute an acceptance of the offer, in accordance with system rules and/or applicable law. The system provides such acceptance to the service seeker 1003. A contract is formed, under the system rules and/or applicable law. FIG. 10D provides a corresponding representation in which a service provider 1011 generates an offer 1013, and a service seeker 1009 accepts such offer, forming a contract 1014.

In certain embodiments, the system may provide a conversational communication module to allow users to ask questions. This communication module may be offered concurrently with the offer/acceptance module. Preferably, however, users using this communication module can use such module to engage in non-binding discussions without any legal consequence as it relates to the contracting of services.

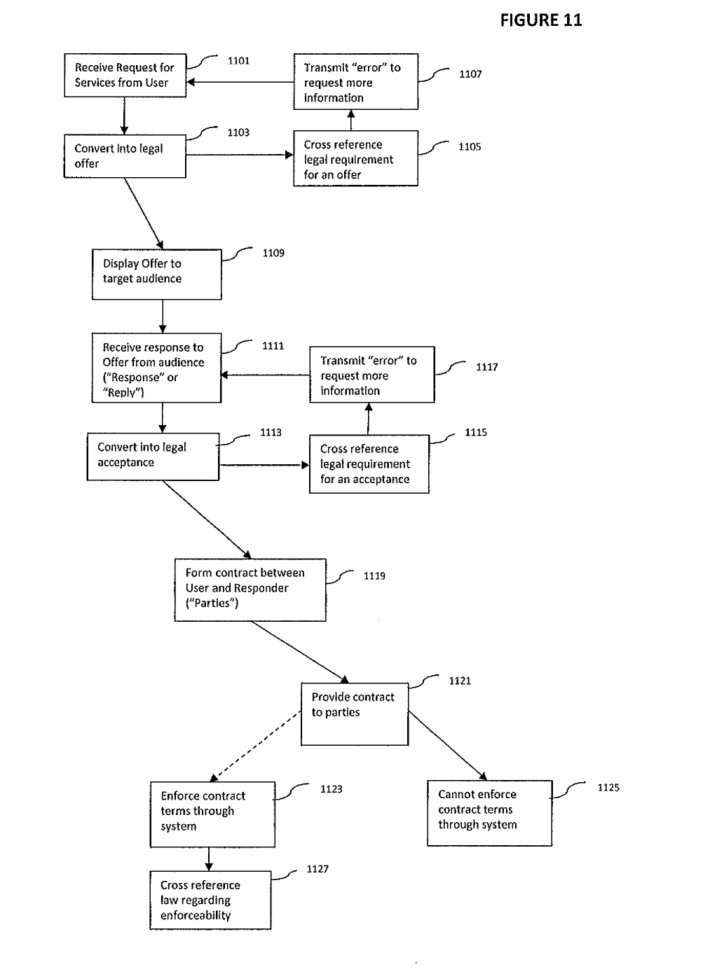

FIG. 11 provides a further overview of the processes included in embodiments of the present invention. Under step 1101, the system receives a request for services (or request to provide services) from a first user. By function of law and/or under the terms of use of the system, the request is “converted” into a legal offer, as shown by step 1103. It is contemplated that steps 1101 and 1103 may not be distinct and separate steps. The system can ensure that the offer is legally-binding by ensuring that the requirements under the law or the system are satisfied, as shown by step 1105. In the event that the requirements are not met, the system can generate an error, which may prompt the system to transmit an error notification to the user creating the request, as shown in 1107.

As shown in step 1109, the legally-binding offer is processed by the system, and displayed (or otherwise presented) to a target audience (as generally shown in FIGS. 10A-D or more narrowly to audiences with specific qualifications, skills, experiences, and/or interests related to the scope or nature of the offer). One or more users may respond to the offer. In steps 1111 and 1113, the system receives a reply, which is deemed to be an acceptance, by function of law and/or under the terms of use of the system. Steps 1111 and 1113 may not necessarily be distinct or separate steps but are shown independently for the sake of clarification. To determine if the reply meets the criteria to be deemed an acceptance, the system can cross-reference requirements in the law or in accordance with the system requirements, as shown in step 1115. In the event that the requirements are not met, the system can generate an error, which may prompt the system to transmit an error notification to the user creating the reply, as shown in 1117.

With the receipt of an acceptance to a corresponding offer, a contract is, or can be, formed, as would be understood under the law, as shown in 1119. In preferred embodiments, contracts are in compliance with applicable laws, including local, state, and federal laws, and any relevant guidelines, regulations, ordinances, statutes, practices, and customs. Embodiments of the invention may account for contracts formed, or legally acknowledged only after ratification, approval, or acknowledgement by a third party, such as a state notary. Additionally, if necessary, the system can transmit sufficient information to a third party to allow the third party to serve as a witness or approver. Such third parties can be users of the system, thus facilitating electronic communication, identification and verification between the system and the third party. The third party can be prompted to acknowledge the contract, such as by executing the contract as a witness, where applicable. Upon the formation of the contract, the system may provide the parties to the contract, and other interested parties, with the contract or contract information. In preferable embodiments, the contract has a unique identifier(s), which allow the contract to be referenced, retrieved, or otherwise available (such as to third-party auditors)

As further noted below, the system can structure the contract so that terms of the contract can be enforced through the system, as shown in step 1123, or preferably, contract terms can be enforced outside the system, such as through conventional litigation, arbitration, mediation, or legal counseling, as represented by step 1125. If the contract can be enforced through the system, the system should be granted or possess powers to settle disputes and address contractual terms. The system can electronically cross-reference applicable laws to adjudicate disputes, as shown in 1127. In some variations, certain aspects of the contract can be enforced by the system, while other aspects can be enforced outside of the system.

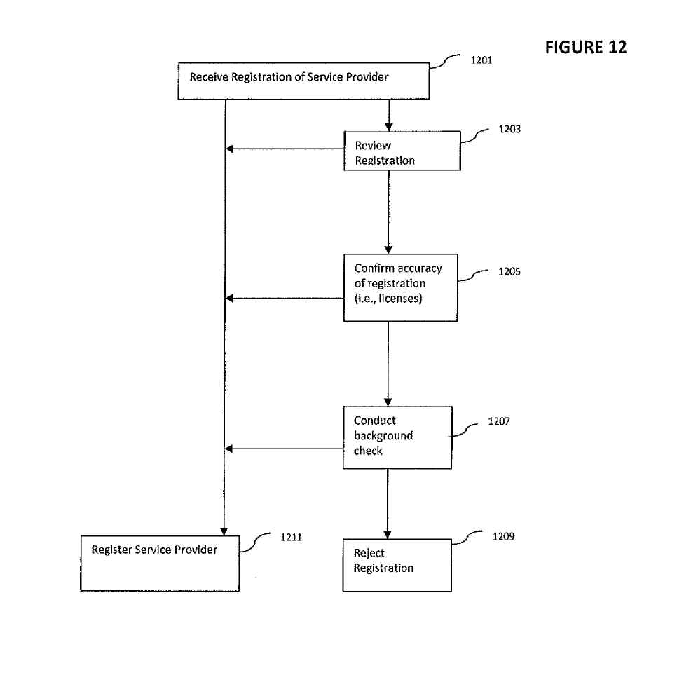

FIG. 12 presents an additional aspect of the present invention in which the system can evaluate and/or confirm the qualifications of the service provider. In step 1201, the service provider submits his/her registration, which includes at least the service provider's licenses, accreditation, or other qualifications. Once this registration is received by the system, the system can conduct a review of the registration, as shown in step 1203. Either electronically or manually, the system may confirm the accuracy of such licenses, accreditation or other qualifications, such as through a background check, as shown in step 1207, or by assessing supporting information and documents (e.g., certificate of good standing with a professional organization). In certain embodiments, the system may assess a fee for such services. The system may then register the service provider, as shown in step 1211, or reject the registration, as shown in step 1209. In additional embodiments, the system may endorse or indicate verification of the service provider's qualifications, such as through a visual symbol linked with the service provider's registration. In some embodiments, the service provider's licenses, accreditations, and other qualifications may be added to a database, such as a relational database, so such licenses, accreditations, and other qualifications are searchable.

The following description provides further detail on the overview presented in FIGS. 10A-D and FIG. 11. Both service providers and service seekers may initiate action. A service provider may submit information for a service that the service provider can perform. Such a submission preferably describes specific, detailed services. The submission may include sufficient details regarding the nature of the services, and as applicable, the locations in which the service is provided, dates, times and timeframes, compensation, the service provider's training, qualifications and/or experience, other promotional content, references, and any other information relevant to service provider's offered services or relevant to service seeker's interest and/or criteria in acquiring services from service provider. In preferred embodiments, each user's activity on the system is recorded and available for user's review. Typically, a user can access his/her activity by logging on to the system and accessing user-specific information or requesting such information from the system. In preferred embodiments, the user-specific information includes a history of user, including information on offers accepted, offers pending, services performed, contractual relationships, and/or offers replied to but not accepted.

A service seeker may submit information, or a request, for a service to be performed and/or delivered by a third party. Such a submission preferably describes the parameters of the service, including sufficient details regarding the nature of the services, and as applicable, the location, the date and timeframe, required tools and/or skills, and the compensation. Preferably, the submission adequately describes the service sought to allow the service provider to understand the request and the nature of the service to be performed.

In more preferred embodiments, the submission, posted by either the service seeker or the service provider, would provide sufficient information so as to constitute a binding offer. As used herein, the user creating the offer is deemed an “offeror,” while the user accepting the offer is deemed an “offeree” or “acceptor.” In preferred embodiments, an offer is defined as an expression of willingness to contract on certain terms, made with the intention that it shall become binding as soon as it is accepted by the person to whom it is addressed. In other preferred embodiments, the offer should provide sufficient detail for a potential accepting party to understand or reasonably understand the nature of the offer. In yet other preferred embodiments, the offer satisfied jurisdictional requirements, such as the jurisdiction in which the service is offered, accepted, and/or performed, as applicable under the law. That is, in such embodiments, the submission posted by either the service seeker or service provider can be legally accepted by the receiving party (the service provider or service seeker, respectively), thereby forming a legally binding contract between the service provider and service seeker.

Submissions posted to the system are presented to the audience through a GUI. In preferred embodiments, submissions are posted to a general listing, similar in functionality to electronic classifieds, bulletin boards, and/or feeds (also commonly referred to as a newsfeed in social networks). Audience members can access such feeds by accessing the system. Submissions seen by each audience member can be optionally customized. For example, the audience member and/or system can adjust the frequency and types of submissions through preference controls. Preferably, the system provides a search functionality to capture submissions, including active submissions (i.e., those submissions currently seeking a response) or archived submissions (i.e., those submissions which are no longer seeking a response).

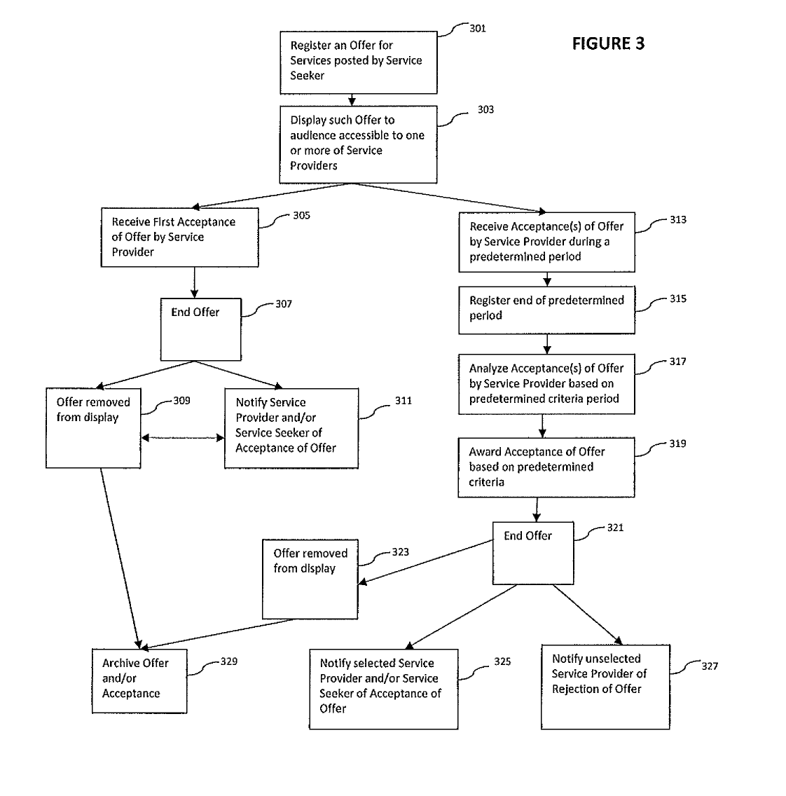

In one embodiment, the system receives the submission, as shown in step 301 in FIG. 3. The system provides such information to an audience of at least one service provider, as shown in step 303. In certain variations, the service provider interested in, or at least inquiring about, performing the service being sought can access the system's communication module to respond to such submission. The communication module may be understood to one in the art. The messaging system may provide direct messaging between the parties. The messaging system may be separate from, and/or supplemental to, the module in which the parties form their contract.

One variation of the embodiments in which the submission is an offer contemplates that the first reply to the submission is deemed the first acceptance, thereby closing the submission (or otherwise prohibiting multiple acceptances). Step 305 illustrates receipt of the first reply by the service provider in response to the service seeker's submission. The party creating the original submission and the party replying with the first acceptance are contractually bound. In the most preferred embodiment, in accordance with general principles of contract law, submissions constituting a legal offer prohibit negotiation of terms or material terms, between the parties.

As shown in step 307, the offer ends (i.e., is deactivated or closed) with such an acceptance. The system may allow subsequent replies from audience members, and as shown in step 311, may provide notice to such audience members that the submission has been closed and contract has been formed. In some variations, the system may establish a “waitlist” in the event that the first contract is breached, broken, or the services otherwise contemplated under the contract are not performed or ill-performed. In preferred variations, the system prohibits audience members to reply once the contract has been formed (i.e., when the submission is closed). The offer may be removed from the audience's list of open (i.e., available) services, as shown in step 309. As shown in step 329, the system may provide archival information on the original submission, and/or the submission and acceptance (including, but not limited to, information or statistics on how long the offer was pending, who the contractual parties are, etc.).

It is also contemplated that a service seeker may select, and in turn, contract with multiple service providers stemming from one offer submission. For example, a service seeker individual may seek delivery of multiple large plain pizzas on a particular night at 7 pm. Conceivably, in such a scenario, a number of service providers of pizza delivery services can contract with one service seeker. In variations of the above embodiment, the requirement that only the first acceptance is accepted is replaced with the requirement that a finite number of acceptances are accepted. This number is any discrete number as identified by the system, or preferably the service seeker. If the value selected is 3, then the system may accept acceptances from 3 different pizza vendors, and close the offer/acceptance period after the third acceptance is received.

In some embodiments, the submission by a user may be open for acceptance for a predetermined time period, either set by the user posting the submission or by the system. In step 313, the system can collect any replies by the audience until the end of the predetermined time period, as shown in step 315. Once the predetermined period has concluded, the system may compile received acceptances, and analyze such received acceptances based on predetermined criteria, as shown in step 317. The predetermined criteria may include a cross-check and/or confirmation of the replying audience member references, qualifications, or licenses, for example. In accordance with applicable laws, in some embodiments, the analysis of predetermined criteria may not result in the initial offer being deemed a solicitation, advertisement, or a classification not satisfying the elements of a contractual offer. After such analysis, as shown in step 319, the system selects one reply, which is deemed the acceptance to the original submission offer. The system may remove, or otherwise disable replies to the offer, at the close of the predetermined period or as shown in steps 321 and 323, concurrently or substantially currently with the awarding of acceptance (i.e., determination of the contractual parties). The system preferably notifies the audience member selected for acceptance, as shown in step 325. In some instances, the system will also notify the unselected audience members, as shown in step 327.

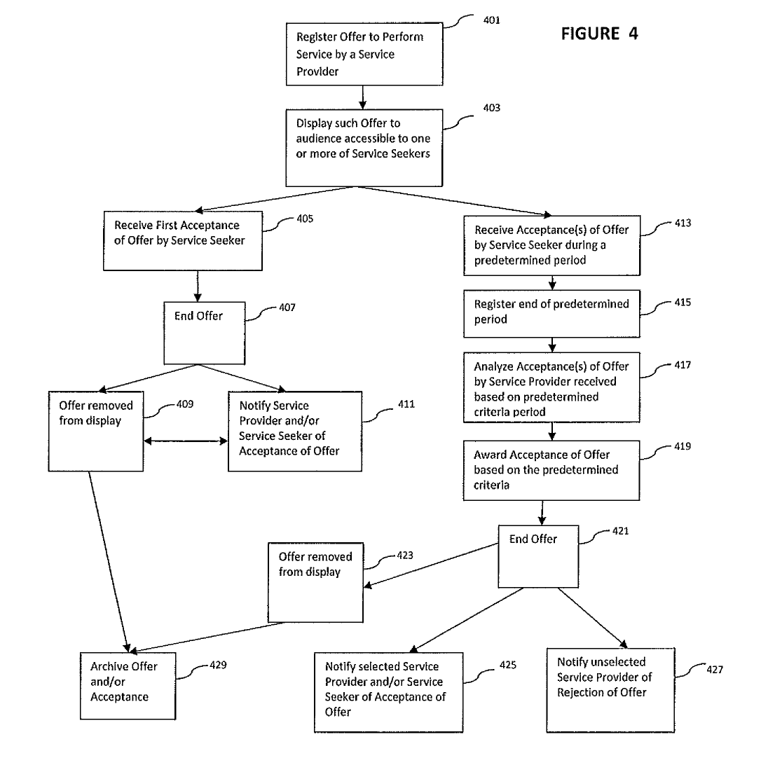

FIG. 4 provides an exemplary flow diagram describing an offer posted by a Service Provider. In step 401, the system receives an offer posted by a service provider, preferably a registered service provider. In step 403, the offer is displayed to the audience of one or more service seekers. In accordance with step 405, the service seeker audience member with the first acceptance received by the system is deemed to be the party to the contract with the service provider. Upon formation of the contract, any outstanding offers end, as shown in step 407, prohibiting subsequent service seekers from responding to or accepting such offer. In step 409, the offer is removed. In step 411, the parties to the contract are notified of their contract. In some embodiments, if responding users are permitted to reply even after the offer is closed, the system preferably generates notice to such users to notify them that their replies will not be deemed offers or to establish a waitlist. Once the offer is removed from “active” or “open” status, the content of the offer or details of the service (including the contractual parties, for example) may become available to audience members, as an archival function, as shown in step 429.

Step 413 contemplates the embodiment in which acceptances can be received from multiple audience members (in this specific illustration, service seekers) for a predetermined period of time, which is set by the system or user posting the offer. The system “closes” the offer as of the predetermined chosen limit of acceptances and/or the predetermined time period, as shown in 417, and subsequently provides an analysis period, in which the acceptances received in the predetermined period are reviewed based on a predetermined criteria (e.g., ensure that the audience member meets certain qualifications). After the analysis is completed, as shown in step 419, the contract is awarded, and the service provider and selected service seeker are entered into a contractual relationship. The offer ends at the time the predetermined period ends or at a time some time thereafter, such as once the contract is awarded, in accordance with step 421. Step 425 illustrates the system's notification to the contracted parties, while step 427 illustrates the systems notification to the parties (e.g., the service seekers) not selected.

In some instances, the service provider may select multiple service seekers. For example, a service provider may offer a limousine service from LaGuardia Airport to Midtown Manhattan for a flat rate of $40 on any weeknight. This service provider can offer this same service multiple times per week, albeit not multiple times during the same time increment. The system may allow this service provider to provide one submission, with details of the cost, the service, and available times. In turn, system may permit multiple service seekers to respond, and contract, for the service providers services over the course of the week. In such instances, the system may permit the service provider to provide time slots, which can only be filled once. Contracts may be formed with service seekers replying to the service provider's offer if the service seeker selects an open time slot.

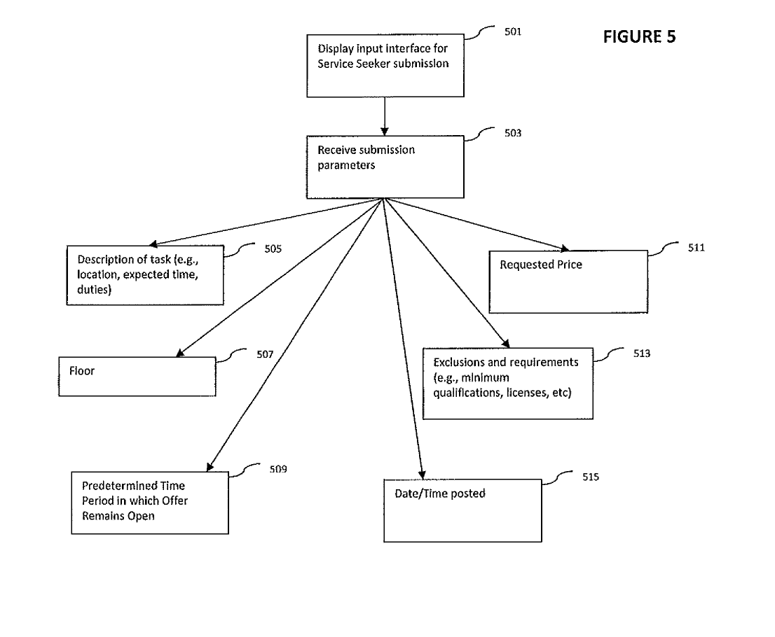

FIG. 5 provides an exemplary illustration of information useful to, required by, or requested for, the service seeker's submission (e.g., an offer, solicitation, or advertisement). The system may provide the service seeker with input options, 1) free form, which allows for narratives and unprompted input, 2) form, which requires specific values, data and information; or 3) a combination thereof. In step 501, the system provides the service seeker with a GUI to input offer information. In step 503, the system receives the submission parameters or details. In some variations, the system parses or otherwise identifies the information provided. Preferably, in such variations, the system determines if basic and/or sufficient information is provided by the user. In more preferred variations, the system identifies if sufficient information is provided to establish a legal offer. In such variations, the system may cross-reference requirements as prescribed by the law in specific jurisdictions. The system may reject a submission if it determines requisite information is not provided. The system may also notify the user of a deficient submission and prompt user to provide additional information. In some embodiments, as shown in step 505, the system ensures that the offer includes a description of the service (i.e., task), including where the task is to be performed (location), when the task is to be performed (date/time), how long the task is expected to take (duration), and what the task entails (service description). The submission may also include a date and time the offer was posted (time stamp), as shown in step 515, as well as a predetermined time period in which the offer is open (i.e., a time when the offer expires and cannot be accepted), as shown in step 509. The offer may include expected requirements, licenses, qualifications, experiences and/or exclusions relevant to the service provider, as shown in step 513.

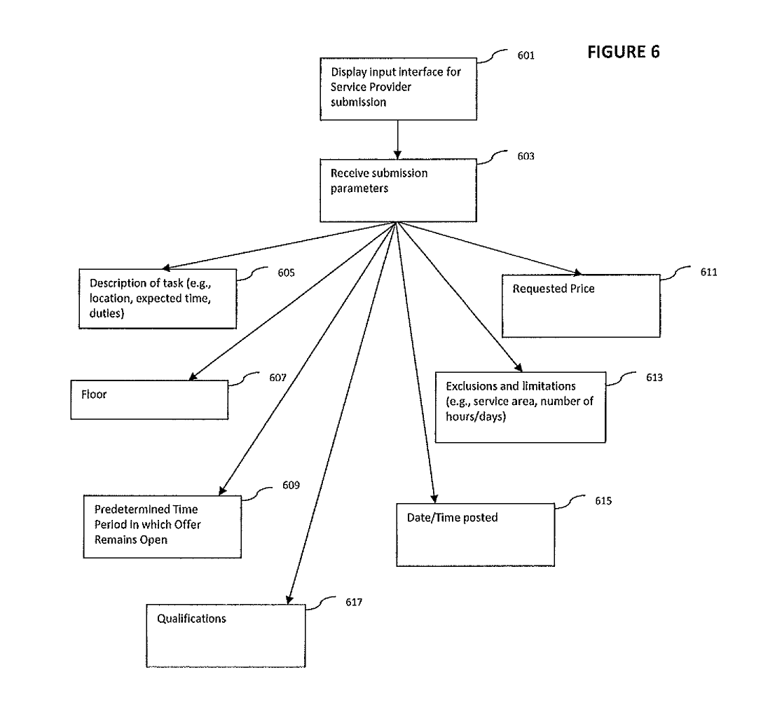

FIG. 6 provides a corresponding exemplary illustration of information useful to, required by, or requested for, the service provider's submission. As noted with respect to FIG. 5, the system may provide the service provider with input options, 1) free form, which allows for narratives and unprompted input, 2) form, which requires specific values, data and information; or a combination thereof. In step 601, the system provides the service provider with a GUI to input submission information. In step 603, the system receives the offer parameters. In some variations, the system parses or otherwise identifies the information provided. In some embodiments, as shown in step 605, the system ensures that the offer includes a description of the service being provided (i.e., task), including where the task is to be performed (location), when the task is to be performed (date/time), how long the task is expected to take (duration), and what the task entails (service description). The offer may also include a date and time the offer was posted (time stamp), as shown in step 615, as well as a predetermined time period in which the offer is open (i.e., a time when the offer expires and cannot be accepted), as shown in step 609. The offer may include expected requirements, licenses, qualifications, experiences and/or exclusions relevant to the service provider, as shown in step 513 and step 617.

The submission (i.e., the service seeker's post as shown in FIG. 5, specifically step 501 or service seeker's post as shown in FIG. 6, specifically step 601), whether deemed to be a legal offer or a solicitation of services, may include a price (i.e., compensation) paid to the service provider to perform the task, which is represented as the requested price in 511 and 611. In certain embodiments, the submission may include rules related to compensation. Often, in conventional marketplaces, replies to advertisements and solicitations requesting services, offer compensation far below the expectations of the party seeking the services. These types of replies are colloquial referred to as “low-balls” or “low-ball offers.” One automated, electronic rule that may be implemented is a floor (i.e., a minimum or base compensation), as set by the system or preferably the user creating the submission, as shown in 507 of FIGS. 5 and 607 of FIG. 6. In preferred embodiments, the floor is not publicly viewable or otherwise accessible to the replying party. Thus, the system identifies the compensation offered by the replying party, and classifies the reply for further action. One variation of the floor is to create a base compensation value that must be present in the reply before the compensation is transferred to, or otherwise displayed by, the system to the user creating the submission. If the proposed compensation value is too low (i.e., falls below the floor), the system may reject the proposed reply, prohibit transfer to the party creating the submission, and optionally notify the party replying. In another variation, the system may aggregate and record replies that may fall below the floor. In this variation, the system may hold and/or record such replies, and in some scenarios, release such offers at the request of the party providing the offer, or based on customizable criteria (e.g., the user posting the submission has not received a requisite number of acceptances on his/her offer).

At a time after the submission (e.g., offer) is posted to the system, the system may process the information. The system may verify the user's submission is accurate and/or meets the system guidelines, terms of use, or other rules. Additionally, such processing may allow the system to store the information, preferably in a database structure as would be understood to one in the art, which can be retrievable and/or made available through queries and/or searches, as would be understood in the art. The system may display the submitted information to the audience in real-time, substantially real-time, or may optionally incorporate a delay, which may correspond to an interim administrative action or may simply be an intentional holding period. The system may display the submission to the entire audience or segments of the audience, as identified by the user making the submission or by the system. For example, a service seeker's submission requesting dry cleaning services may only be displayed to service providers identified as providing dry cleaning services. Users may self-identify segments of interest or experience, or the system may do so based on information processed from user-profiles, user's use of the system, comment, or any other information available to the system.

The system provides the audience in receipt of, or viewing, the submission to create or generate a response. Generally, if the submission is deemed to be, or is considered to be, a non-negotiable offer, the system would preferably limit the form of the replies to legally binding, non-negotiable acceptances. As with the submission, the system may be optimized to provide replies that are free form, form, or a combination thereof. The system may provide or prompt the replying party to provide information sufficient to constitute a binding offer.

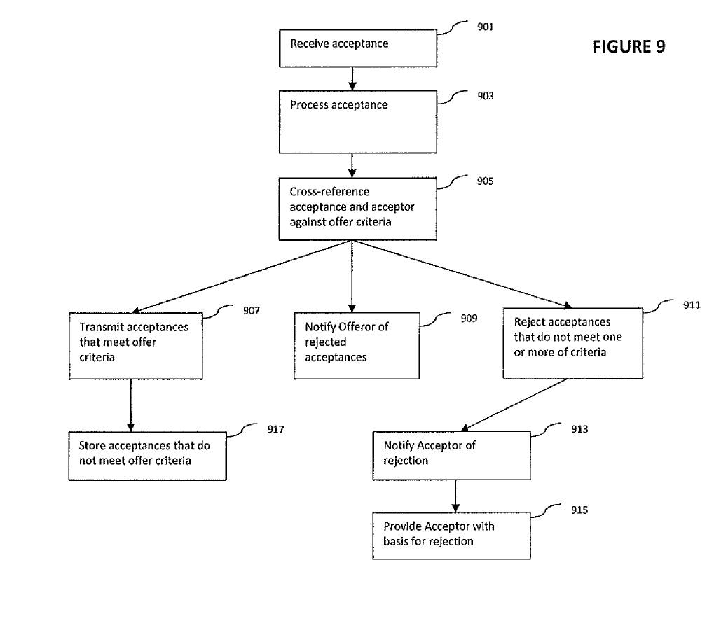

FIG. 9 provides an exemplary overview of the acceptance process. In step 901, the system receives an acceptance. The system processes such acceptance in step 903. As shown in step 905, the system may cross-reference the terms (i.e., criteria) in the offer to ensure that the acceptance meets or addresses such terms. For acceptances that meet the terms in the offer, as shown in step 907, the acceptances (or notice thereof) would be forwarded or displayed to the user creating the offer. Acceptances meeting or not meeting the terms of the offer may be aggregate and/or stored. As shown in steps 909, 911, 913, and 915, the system may include notification modules to provide replying parties with information on their replies, including, for example, whether such reply was received, rejected (and optionally, the basis for such rejection), forwarded, and/or accepted.

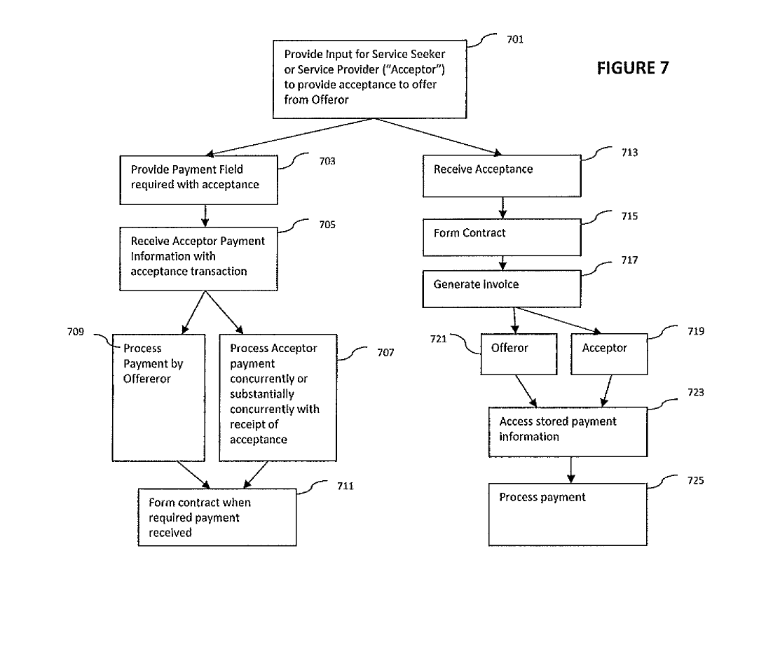

FIG. 7 provides an exemplary payment processing flow diagram, which assesses fees (e.g., transactional fees) to one or more parties in a transaction between a service provider and a service seeker. In some variations, the system assesses such fees on the party making the submission, the party replying to the submission, or both. In step 703, the system provides the user with a payment field in the process of accepting an offer. The payment field may include a prompt for payment card information (PCI) (e.g., credit card or debit bank information), bank information, other financial account information, or other forms of currency, including gift cards. In some variations, the system may reference a user's user profile, which may already include such payment information. Similar information may be collected before a user creates a submission. In step 705, the system receives the acceptance with the payment information. In steps 707 and 709, the system processes the payment, and in step 711, the system acknowledges or creates a contract concurrently or after payment is received from one or more parties, as required. Additional payment structures, including subscription terms, may be supplement or replace transactional fees.

In step 713, the system receives acceptance of an offer, and a contract is formed in step 715. Following the formation of the contract, an invoice is generated, as shown in step 717. The invoice is sent to the user creating the offer, step 721, and/or the user accepting the offer, step 719. The invoiced parties may pay the invoice, preferably electronically, or as shown in step 723, the system may access stored payment information, preferably stored in the user profiles. Once received, as shown in 725, the payment is processed.

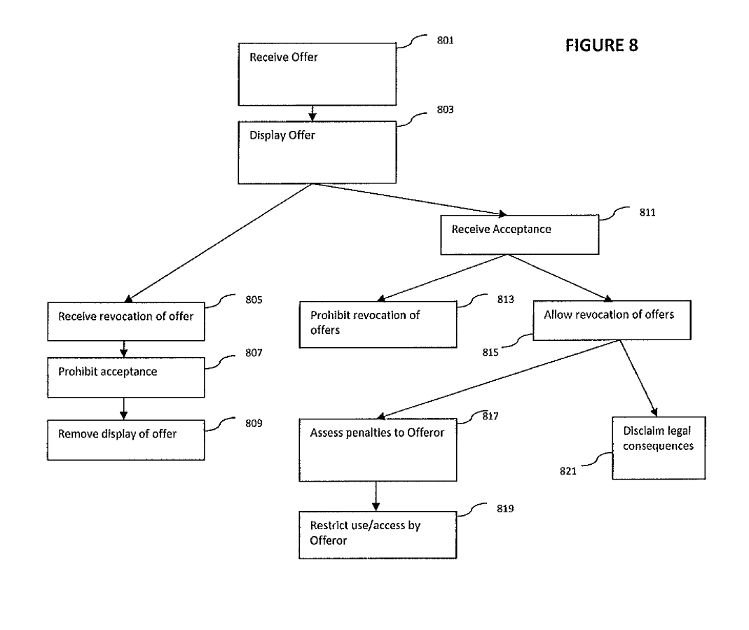

It is contemplated that in some instances users may create a submission seeking services or providing services for which the user is no longer seeking or providing. Certain embodiments would provide such users to terminate, rescind, or revoke their submissions. In FIG. 8, the system receives the offer in step 801 and subsequently displays such offer in step 803. In this exemplary embodiment, the offer is deemed to be legally binding. In a preferred embodiment, the user's ability to rescind and/or the systems technical ability to rescind (i.e., pull back a user's submission) is in accordance with applicable laws. In certain scenarios, the system may allow a complete rescinding of the offer if a replying party was not prejudiced (e.g., detrimentally rely) by such offer.

For example, the party creating the offer seeks revocation of the offer before any party replies. The party creating the offer would notify the system. In step 805, the system receives the revocation, and subsequently prohibits acceptance of the offer, as shown in step 807. The system remove the offer from the list of offers displayed to the audience, as shown in 809, or may continue to display such offer but deactivate the ability for a user to reply to such offer.

In step 811, the scenario illustrated is where the offer has received a reply which constitutes an acceptance. Accordingly, the system recognizes a legally binding contract. In preferred embodiments, the laws applicable to this transaction govern its resolution, particularly if one party wishes to exit the contract. In step 813, the system may prohibit revocation of the offer. In such a scenario, the contracting parties may be allowed to seek remediation through conventional and/or available legal means. In an alternative scenario, as presented in step 815, the system may allow a party to revoke the offer (or acceptance). This may require the system to disclaim legal consequences, as shown in step 821, if possible. In some instances, the system may assess a penalty to the offeror wishing to cancel or the acceptor wishing to cancel. One such penalty is to restrict use or access to the system by these parties, as shown in step 819. In some scenarios, the system may ban a user for any violation of the systems terms of use or law or at its discretion.

In preferred embodiments, the only parties in a contractual relationship are the user submitting the offer and the user(s) accepting the offer. In these preferred embodiments, the system, including any administrators, organization owning and/or operating the system, and employees thereof, are not party to the contract. All disputes or legal issues, including questions regarding contractual interpretation, warranty, nonperformance, remedies, termination, and other terms, shall be determined by law applied by the applicable body or jurisdiction in the proper venue, as would be understood to one skilled in the art. In preferred embodiments, the system may retain legal records, including the contract, the offer, the acceptance, dates, and times, for certain periods. In such embodiments, such records may be accessible by users, administrators, or by legal action, such as subpoenas or requests for information.

Some embodiments of the present invention include a contractual structure wherein the user creating the offer, the user accepting the offer, and the system are in a contractual relationship. For example, this structure may include the user creating the offer and user accepting the offer being contractually bound, and the system being contractually bound to each of the user creating the offer and the user accepting the offer. In such a structure, the system may have legal rights to enforce the contract, particularly performance by the parties (e.g., payment by one party and performance by the other party).

The system may assist with disputes between the user creating the offer and the user accepting the offer, as permitted under the law. In preferred embodiments, the system may enforce parties by creating incentives and penalties associated with the use of the system (e.g., website). For example, the system may create a rating/ranking system, which allows system users to provide feedback and comments on other users. The system may also restrict access and use by users.

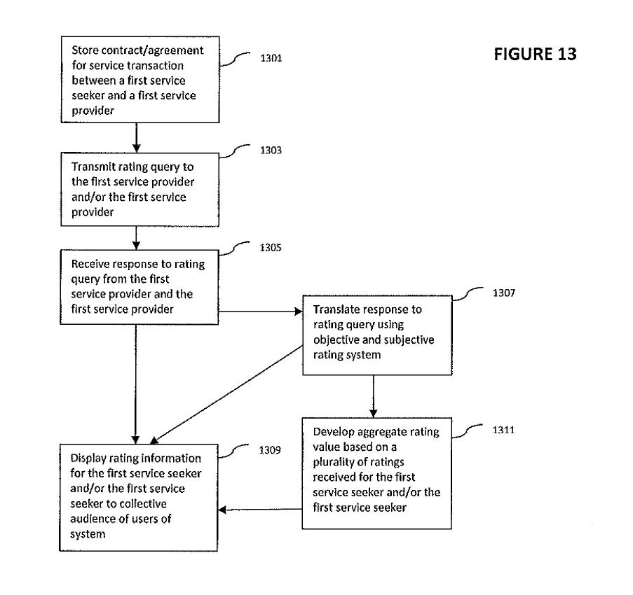

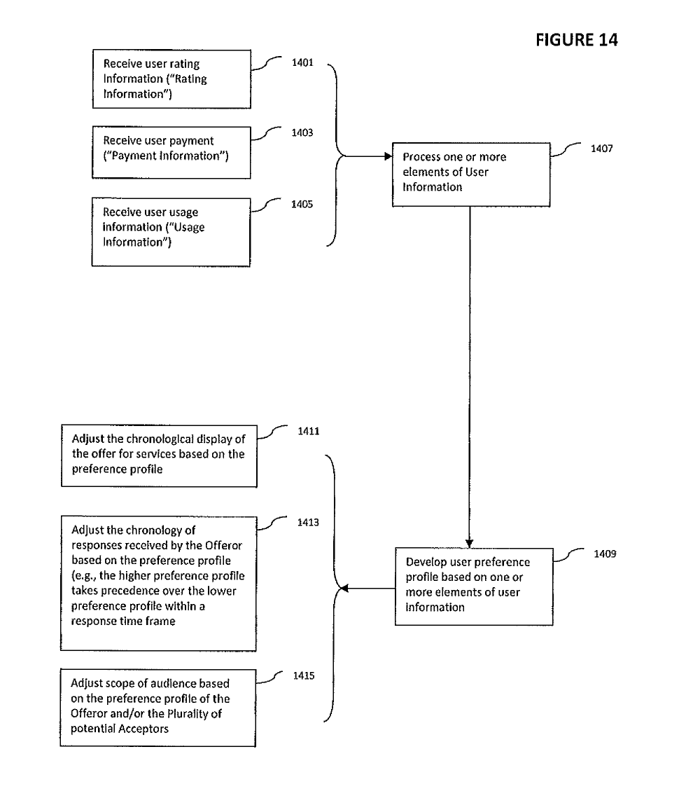

Certain embodiments of the present invention may include a social network or rating systems, to allow users to comment and/or rate other users. FIGS. 13 and 14 provide an exemplary implementation of a ratings module in the present invention. In step 1301, an agreement between the service provider and service seeker is stored, and referenced as the basis for the relationship between a service provider and seeker. In step 1303, the system transmits a rating query (e.g., a rating survey) to the service provider and/or service seeker. The rating query may include objective and subjective factors. Step 1305 involves receiving the completed rating queries from the parties. As shown in step 1307, the responses in the completed ratings survey are assessed, generating a user rating value. In step 1311, the system may compile multiple rating queries for a specific user and aggregate them for a user rating value. As shown in step 1309, the system provides access to the user rating value, and in some embodiments to the underlying completed ratings query, to other users accessing the system.

FIG. 14 further illustrates the system's processing of user information. As shown in steps 1401, 1403, and 1405, the system receives exemplary user information, such as user rating value/information, payment information (e.g., information on whether the user has timely paid for services), and user's system usage. In step 1407, the system processes the user information to compile and interpret the information, based on an algorithm to weigh each item of user information. In step 1409, the system may develop a user preference profile, which may identify “trusted” or “top” users to other users. Based on this preference profile, the system may amend or adjust the service listings on the system. In step 1411, the system may adjust the chronological display of offers. For instance, a top user may have his/her offer posted at the top of the listings or in a highlighted graphical box at the top of the page. In step 1413, the system may adjust the chronology of responses. In step 1415, the system may adjust the universe of users who have access to an offer/submission.

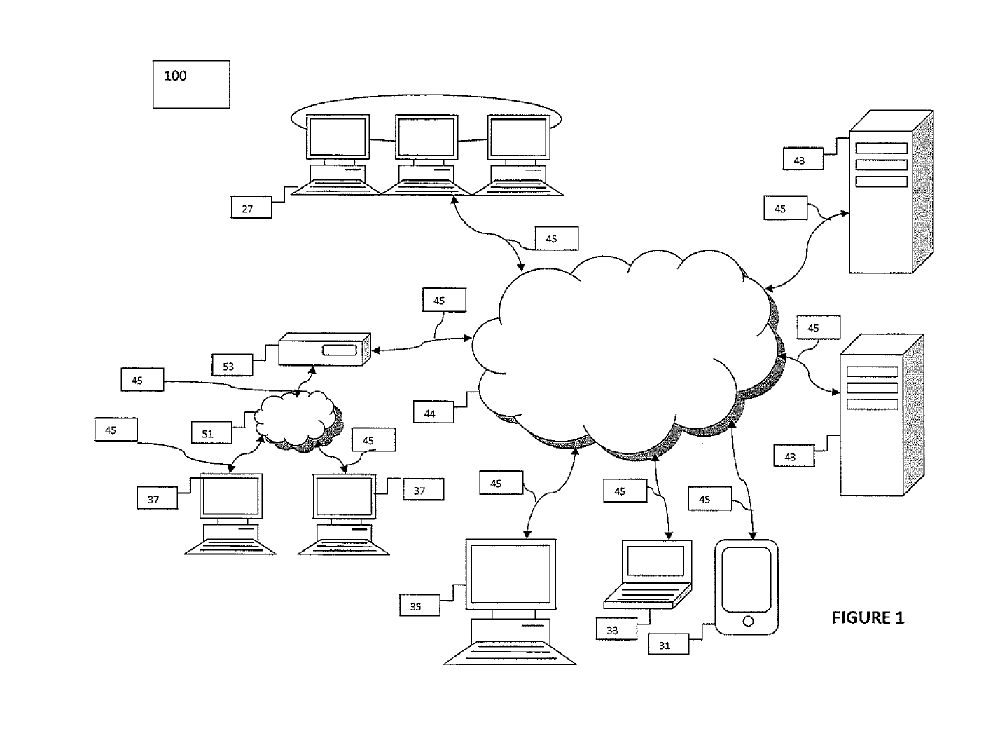

FIG. 1 illustrates a network in which an exemplary embodiment of the present invention may operate. The network may include any type of interconnected computer technologies and/or devices (including mobile devices (e.g., smartphones), computers and other hardware having a processor and a repository for data or connection to a repository for maintained data) (interchangeably referred to herein as “computers”). The network may be public or private, or a hybrid thereof. The network may include conventional network backbones, long-haul telephone lines, internet service providers, routers, switches, and other means for routing data/information between computers. The network connections would be understood to one skilled in the art, and may include wired, wireless, or fiber optic connections. Computer networks would be well known in the art, including, for example, a local area network (LAN), wide area network (WAN), personal area network (PAN), near me area network (NAN), home area network (HAN), storage area network (SAN), campus area network (CAN), metropolitan area network (MAN), backbone network, enterprise private network, virtual private network (VPN) or any combination thereof. Networks include near field communication (NFC) and Bluetooth network standards. Another network, and the preferred network as noted above, is the Internet.

Computers may communicate through a conventional means, such as through one or more network protocols (e.g., TCP/IP) to a plurality of clients or terminals 27, 31, 33, 35, 37, 43. In this network architecture, a server computer system 100 and terminals 31, 33, 35 are directly coupled to WAN (e.g., Internet) 44. Terminals 27 represent a conventional modem pool. Terminals 37, which form a sub-network 51, such as a LAN, represent an alternative connection to the WAN via a gateway 53. In this manner, terminals can communicate with one another through the LAN or with server 43 through the gateway 53 via the WAN 44.

Information may be input via a terminal (also referred to as “device”), such as a microcomputer, personal computer (PC) 35, portable personal computer 33 (e.g., notebook, laptop, netbook, minicomputer), server or mainframe computer 43, ultraportable device 31 (e.g., telephone or smartphone device, personal digital assistant (PDA), tablet, gaming console, or other device having a processor and input capability.

In a particular implementation of this network configuration, a server computer 43 may operate as a web server if the Internet's World-Wide Web (WWW) is used for wide area network 44. Using the HTTP protocol and the HTML coding language across wide-area network 44, web server 100 may communicate across the World Wide Web with terminals 27, 31, 33, 35, 37. In this configuration, terminals 27, 31, 33, 35, 37 use a client application program known as a web browser such as the Explorer® (Microsoft Corporation, Redmond, Wash.) or the web browser, executable program or HTML renderer of any other supplier. Using such conventional browsers and the WorldWide Web, terminals 27, 31, 33, 35, 37 may access image, graphical, and textual data provided by web server 43 or they may run Web application software. Conventional means exist by which clients 27, 31, 33, 35, 37 may supply information to web server 43 through the Worldwide Web 110 and the web server 43 may return processed data to terminals 27, 31, 33, 35, 37.

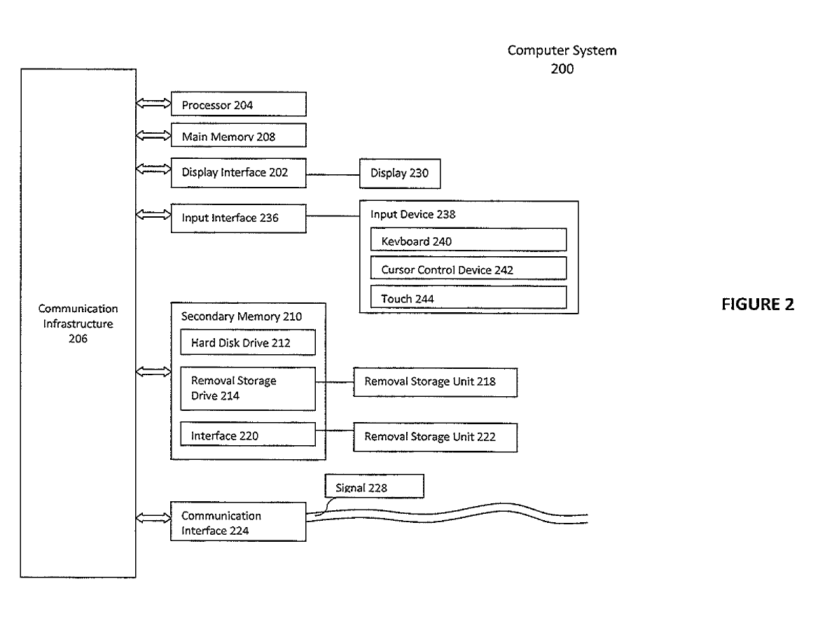

FIG. 2 illustrates an exemplary computer system 200 of terminals 27, 31, 33, 35, 37 and server 43. As shown in FIG. 2, computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230 (e.g., a CRT or LCD display). The display unit 230 may display information (e.g., text, video, graphical depictions) via a graphical user interface (GUI) to a computer user. Computer system 200 can further include an input interface allowing a user to input commands (text or graphical user interface commands, for example) via a cursor control device (e.g., a mouse), a keyboard for alpha-numeric input, or touch-based system (e.g., capacitive touch or general touch screen device, which may be functionally linked to the display unit 230).

Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, flash media, cloud storage device, etc. The removable storage drive 214 reads from and/or writes to a removable storage unit 218 in a well-known manner. Removable storage unit 218, represents a floppy disk, magnetic tape, optical disk, flash media, cloud storage device, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program disk/cartridge and cartridge/disk interface (such as that found in dedicated video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Additionally, computer system 200 may include a communications interface 224. Communications interface 224 allows software and data to be transferred between computer system 200 and external devices. Examples of communications interface 224 may include a modem, a network interface (such as an Ethernet card or wireless access card or point or hotspot, Token ring, etc.), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. The computer system 200 may be coupled to a number of servers 43 and/or other terminals 27, 31, 33, 35, 37 via a conventional network infrastructure, such as the infrastructure illustrated in FIG. 1 and described above.

In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products and computer-implemented processes.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software. Additionally, the system of the various embodiments includes software, information processing hardware, and various processing steps, which will be described below. The features and process steps of the various embodiments may be implemented in machine or computer executable instructions. The instructions can be used to cause a general purpose or special purpose processor, which is programmed with the instructions to perform the steps of the various embodiments. Alternatively, the features or steps of the various embodiments may be performed by specific hardware components that contain hard-wired logic for performing the steps, or by any combination of programmed computer components and custom hardware components.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon. Aspects of the present disclosure may be embodied as a system, method or computer program product. Any combination of one or more computer readable medium(s) may be utilized.

While various embodiments will be described with reference to the Internet, the method and apparatus described herein is equally applicable to other network infrastructures or other data communications systems, as discussed above. Various embodiments are described as implemented in computer-implemented processing logic denoted herein as the “Software”. As described above, however, the claimed invention is not limited to a purely software implementation.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising” and “includes” and/or “including,” when used in this specification, specify the presence of stated features, integers, steps, operations, elements, and/or components, but do not preclude the presence or addition of one more other features, integers, steps, operations, element components, and/or groups thereof.

Although preferred embodiments of the invention have been described in the foregoing description, it will be understood that the invention is not limited to the specific embodiments disclosed herein but is capable of numerous modifications by one of ordinary skill in the art. The description of the present disclosure has been presented for purposes of illustration and description, but is not intended to be exhaustive or limited to the disclosure in the form disclosed. It will be understood that the materials used and technological details may be slightly different or modified from the descriptions herein without departing from the methods and compositions disclosed and taught by the present invention. Many variations and modifications will be apparent to those of ordinary skill in the art. Any corresponding structures, materials, steps, acts, and equivalents of all means or step plus function elements in the claims below are intended to include any structure, material, or act for performing the function in combination with other claimed elements as specifically claimed.

I claim:

1. A computer-implemented, electronic method to facilitate a marketplace among service seekers and service providers for services in which a service seeker acquires services and a service provider provides services, the method comprising:
hosting a computer-implemented electronic portal to facilitate an electronic communication between a plurality of users communicably linked through a network;
wherein the plurality of users consists of a group comprised of one or more service seekers and a group comprised of one or more service providers;
wherein the communication is between the group of one or more service seekers and the group of one or more service providers;
wherein the communication is initiated by a member of a first group;
wherein the communication is comprised of a description of a service and value of the service;
providing a graphical user interface to record the communication initiated by a member of the first group;
receiving the communication initiated by the member of the first group;
processing the communication to be electronically accessible and displayable to one or more members of a second group;
making the communication electronically accessible to the one or more members of the second group;
electronically receiving one or more response communications from the one or more members of the second group;
processing the one or more response communications; and
making the one or more response communications electronically accessible to the member of the first group initiating the communication.

2. The method of claim 1, further comprising:
treating the communication initiated by the member of the first group as a binding offer;
selecting the response communication of a member of the second group based on a predetermined condition;
treating the selected response communication as a binding acceptance;
electronically transmitting the selected response communication to the member of the first group initiating the communication;
recording the offer from the member of the first group initiating the communication and the acceptance from the selected member of the second group as a contract; and
notifying the member of the first group initiating the communication and the selected member of the second group of the contract.

3. The method of claim 2, wherein the predetermined condition is the response communication of the selected member is the first response communication received.

4. The method of claim 3, further comprising:
notifying the one or more members of the second group other than the selected member of denial of the response communication; and
disabling functionality to respond to the communication initiated by the member of the first group.

5. The method of claim 1, wherein the communication initiated by the member of the first group meets the requirements of a legal offer the response communication meets the requirements of a legal acceptance.

6. The method of claim 13, wherein the offer and acceptance are enforceable.

7. The method of claim 1, further comprising:
enforcing the contract against the member of the first group or the member of the second group through restrictions related to usage of the exchange.

8. The method of claim 1, wherein the first group consists of the service seeker and the second group consists of the service provider.

9. The method of claim 1, wherein the first group consists of the service provider and the second group consists of the service seeker.

10. The method of claim 1, wherein the portal has a graphical user interface, wherein the plurality of users are limited by a minimum age requirement, and the network is the internet.

11. The method of claim 1, wherein the response communication is required to be received during a predetermined period and response communications received during the predetermined period are transmitted to the first group initiating the communication.

12. The method of claim 11, wherein the predetermined period is within 72 hours of transmitting the communication to the one or more members of the second group.

13. The method of claim 1, further comprising:
evaluating the received response communications based on predetermined criteria;
processing the evaluation of the received response communications based on such predetermined criteria; and
transmitting the received response communications that meet the predetermined criteria to the member of the first group initiating the communication.

14. The method of claim 13, wherein the communication further comprises a minimum acceptable value for the services and the response communication comprises a value that is greater than or equal to the minimum value.

15. The method of claim 14, wherein the response communications are ordered by value, and the response communications are transmitted in the order of highest value to lowest value.

16. The method of claim 1, wherein the communication is accessible to a segment of the second group.

17. The method of claim 1, further comprising:
assessing a transaction fee for the selected member of the second group.

18. The method of claim 17, further comprising:
assessing a fee for the member of first group initiating the communication.

19. A processor-readable medium storing code representing instructions to cause a processor to perform a process to engage in a transaction using virtual funds, said code comprising code to:
host a computer-implemented electronic portal to facilitate an electronic communication between a plurality of users communicably linked through a network;
wherein the plurality of users consists of a group comprised of one or more service seekers and a group comprised of one or more service providers;
wherein the communication is between the group of one or more service seekers and the group of one or more service providers;
wherein the communication is initiated by a member of a first group;
wherein the communication is comprised of a description of a service and value of the service;
provide a graphical user interface to record the communication initiated by a member of the first group;
receive the communication initiated by the member of the first group;
treat the communication initiated by the member of the first group as a binding offer;
process the binding offer to be electronically accessible to one or more members of a second group;
receive one or more response communications corresponding to the one or more members of the second group;
process the response communications;
select the response communication of a selected member of the second group;
transmit the selected response communication to the member of the first group initiating the communication;
treat the selected response communication as a binding acceptance;
record the offer from the member of the first group initiating the communication and the acceptance from the selected member of the second group as a contract; and
notify the member of the member of the first group initiating the communication and the selected member of the second group of the contract.

20. A computer-implemented, electronic system, which comprises:
an electronic processor;
a data bus coupled to said processor; and
a computer-usable medium embodying computer code, said computer-usable medium being coupled to said data bus, said computer program code comprising instructions executable by said processor and configured for:
hosting a computer-implemented electronic portal to facilitate an electronic communication between a plurality of users communicably linked through a network;
wherein the plurality of users consists of a group comprised of one or more service seekers and a group comprised of one or more service providers;
wherein the communication is between the group of one or more service seekers and the group of one or more service providers;
wherein the communication is initiated by a member of a first group;
wherein the communication is comprised of a description of a service and value of the service;
providing a graphical user interface to record the communication initiated by a member of the first group;
receiving the communication initiated by the member of the first group;
treating the communication initiated by the member of the first group as a binding offer;
processing the binding offer to be electronically accessible to one or more members of a second group;
electronically receiving one or more response communications corresponding to the one or more members of the second group;
processing the response communications;
selecting the response communication of a selected member of the second group;
electronically transmitting the selected response communication to the member of the first group initiating the communication;
treating the selected response communication as a binding acceptance;
recording the offer from the member of the first group initiating the communication and the acceptance from the selected member of the second group as a contract; and
notifying the member of the first group initiating the communication and the selected member of the second group of the contract.
